(19) United States
(12) Patent Application Publication
(10) Pub. No.: US 2014/0006777 A1
(43) Pub. Date: Jan. 2, 2014

(54) Establishing Secure Communication Between Networks

(71) Applicant: OSlsoft, Inc., San Leandro, CA (US)

(72) Inventor: Dariush M. Amiri, San Francisco, CA (US)

(21) Appl. No.: 13/930,950

(22) Filed: Jun. 28, 2013

Related U.S. Application Data
(60) Provisional application No. 61/666,546, filed on Jun. 29, 2012.

(51) Int. Cl. H04L 29/06

(52) U.S. Cl. CPC H04L 63/0823
USPC 713/158; 713/155; 713/156

(57) ABSTRACT

A network traversal module in a branch node enables the establishment of secure communication between networks. The module allows devices on otherwise disconnected networks to communicate collected data to a root node for storage and analysis. The network traversal module supports auto configuration, and includes both a client-side functionality of accessing open ports or services, and server-side functionality of providing open ports or services. Each branch node is responsible for collecting data from client devices on its network or sub-network, and transmitting that data to the higher nodes. Each branch node is also responsible for retransmitting data received from lower nodes to higher nodes. In one embodiment, the network traversal module includes components to allow it to support authentication and revocation of certificates. A root node generates certificates. Each branch node is assigned a certificate, and uses that certificate to access and authenticate itself to other branch nodes.

### CROSS REFERENCE TO RELATED APPLICATIONS

This application claims the benefit of and priority to U.S. Provisional Patent Application No. 61/666,546, titled “Establishing Secure Communication Between Networks” and filed on Jun. 29, 2012, the contents of which are incorporated by reference herein in their entirety.

### BACKGROUND

1. Field of Art

The disclosure generally relates to the field of secure communications, and more specifically to the field of inter-network communications.

2. Description of the Related Art

Process control networks are often used in industry to monitor and control manufacturing and assembly processes. To protect the integrity of these networks, they are often physically isolated from larger networks, such as the Internet. However, given the rise of remote data storage and analysis, it is desirable to allow process control networks to communicate collected data outside of the process control network, without undermining the security of the process control network.

One approach to this problem is the use of dedicated firewalls and proxy servers. The firewalls secure the process control network, and the proxy servers allow data to move through the firewall, but these solutions are not ideal. Proxy servers are difficult to set up and maintain, and they require dedicated equipment.

Configuration details can often complicate implementation of proxy servers. In case of network setup changes, the proxy server must be changed in a timely manner and must be performed correctly to avoid exposing the process control network to external attack and disrupting legitimate data traversal for remote storage and analysis. Additionally, configuration choices at proxy servers can limit the type of information that moves through them. For example, a proxy server might be configured to allow only collected data to traverse the network. However, if the clients inside of the process control network rely on certificates to validate the authenticity of the data, then these clients may not be able to properly renew or cancel their certificates with the signing authority because the proxy server was not configured to allow traversal of that information. Even if the proxy is configured correctly, but the signing authority changes, then the proxy server would have to be reconfigured for this new signing authority in another time consuming and risk-prone process.

### SUMMARY

A network traversal module in a branch node enables the establishment of secure communication between networks. The module allows devices on otherwise disconnected networks to send collected data to a root node for storage and analysis. The network traversal module supports autoconfiguration, and includes both client-side functionality of accessing open ports or services, and server-side functionality of providing open ports or services.

At least one branch node is attached to each network or sub-network, and each branch node may have one or more higher nodes and one or more lower nodes. The higher nodes are nodes that are closer to the root node in the network topology, and the lower nodes are nodes that are farther from the root node in the network topology. Various types and combinations of network topologies are supported. The network traversal modules of each branch node are responsible for collecting data from client devices on its network or sub-network and transmitting that data to the higher nodes. Each network traversal module in a branch node is also responsible for retransmitting data received from lower nodes to higher nodes.

The network traversal module includes components to allow it to support authentication and revocation of certificates. The root node is capable of generating certificates, such as X.509 certificates. Each branch node is assigned a certificate, and uses that certificate to access and authenticate itself to other branch nodes. When receiving collected data from a lower level node, the network traversal module authenticates the certificate of the node that originally collected the data before forwarding data to higher level nodes. Eventually the collected data reaches the root node, which also authenticates the certificate of the node that originally collected the data. Each node may also include a certificate revocation list that can be automatically updated with revoked certificates. The multi-level authentication process thus builds a chain of trust across multiple secure networks that allows certificate services, such as Active Directory Certificate Services, to be used across multiple networks for collection of data.

### BRIEF DESCRIPTION OF DRAWINGS

The disclosed embodiments have other advantages and features which will be more readily apparent from the detailed description, the appended claims, and the accompanying figures. A brief introduction of the figures is below.

FIG. 1 illustrates one embodiment of a system environment supporting secure communication between networks.

FIG. 2 illustrates one embodiment of a branch node supporting secure communication between networks.

FIGS. 3A-E illustrate flowcharts of various scenarios for secure communication between networks.

### DETAILED DESCRIPTION

### System Architecture

In one embodiment, a system for providing secure communications in a network topology is disclosed. The system comprises a first node (e.g., lower branch node) coupled to a first network. The first node includes a certificate associated with the first node and a first module adapted to send collected data via the first network using the certificate. A second node (e.g., higher branch node) is coupled to the first network and a second network. The second node includes a second module adapted to receive the data via the first network, to authenticate the certificate based on a public key associated with the certificate, and to send the collected data via the second network responsive to authenticating the certificate. A third node (e.g., root node) is also coupled to the second network. The third node is adapted to receive the collected data via the second network, to authenticate the certificate based on the public key associated with the certificate of the first node, and to store the data responsive to authenticating the certificate.

In one embodiment, a method for providing secure communication in a network topology is disclosed. The method comprises receiving collected data from a first node, the first node including a certificate for the first node. The collected data is received at a second node via a first network. The method also includes authenticating, at the second node, the certificate for the first node based on a public key associated with certificate. The method further includes sending the collected data from the second node to a third node via a second network responsive to authenticating the collected data. The third node authenticates the certificate for the first node based on the public key associated with the certificate and stores the collected data responsive to authenticating the certificate for the first node. In one embodiment, disclosed is a non-transitory machine readable medium storing code for performing the method.

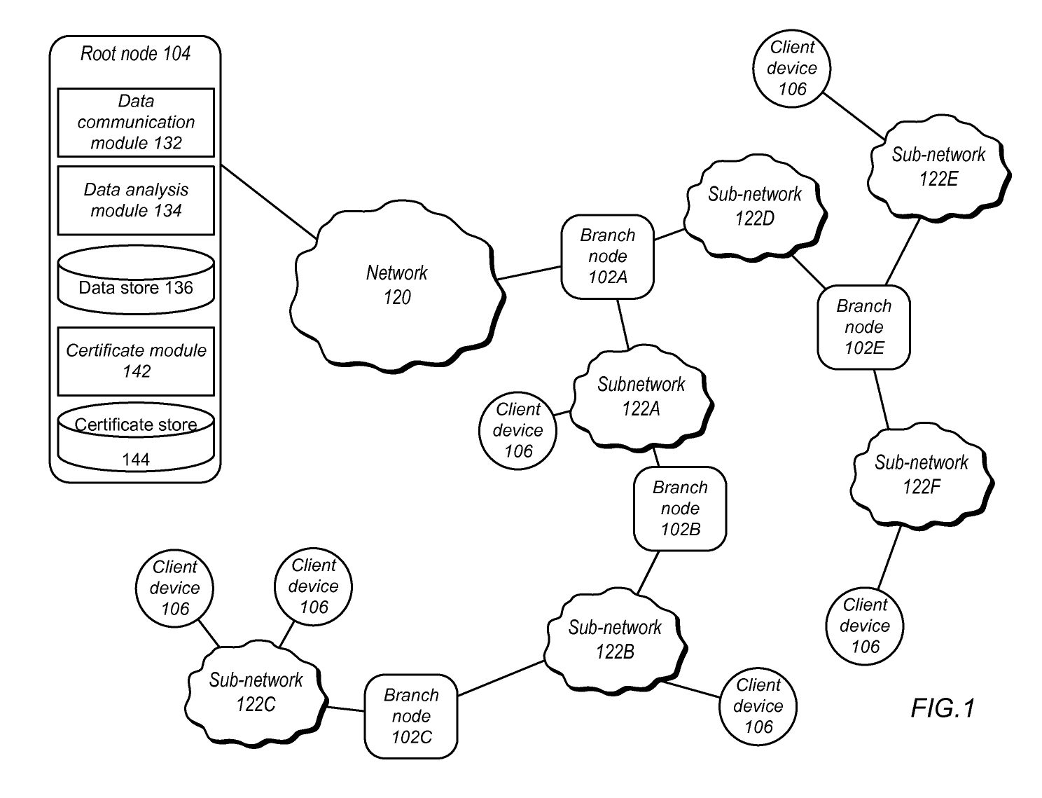

FIG. 1 illustrates one embodiment of a system environment supporting secure communication between networks. The system environment includes one or more branch nodes 102, one or more root nodes 104, and one or more client devices 106. These components are connected by a network 120 and one or more sub-networks 122. For the sake of clarity, FIG. 1 depicts only one representative system environment, though any possible system environment or network topology can support secure communication between networks. In one embodiment, branch nodes 102, root node 104, and client device 106 are computer systems.

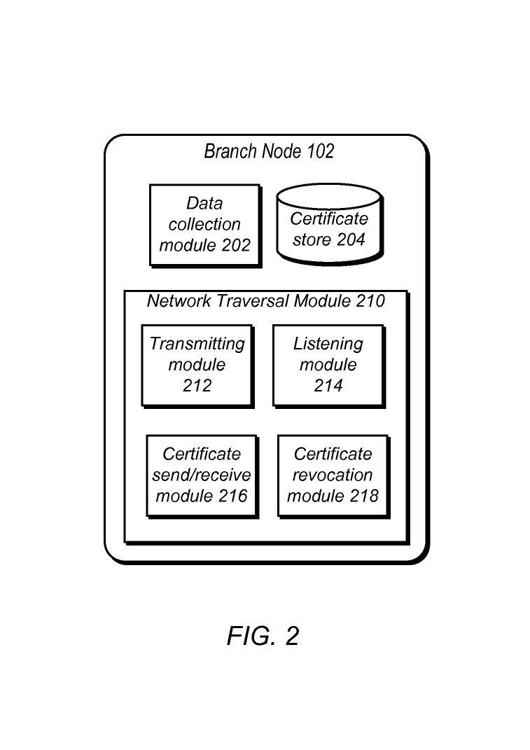

The branch nodes 102 contain network traversal modules (not shown), which enable secure communication between networks. The branch nodes and network traversal modules are described below with respect to FIG. 2. Branch nodes 102 communicate with other branch nodes 102, root nodes 104, and client devices 106. The branch nodes 102, client devices 106, and sub-networks 122 are arranged in a network topology. Each branch node 102 and client device 106 can be viewed as residing in the network 120 and/or sub-network 122 that it is coupled to. For example, branch node 102C and the two client devices 106 are part of sub-network 122C. Branch node 102B, branch node 102C, and one client device 106 are part of sub-network 122B.

FIG. 1 shows a tree topology, where a branch node 102 acts as a gateway for one or more sub-networks 122. For example, branch node 102C collects data from all client devices 106 connected to sub-network 122C. Branch node 102B collects data from all client devices 106 and branch nodes 102 connected to sub-network 122B, which includes branch node 102C. Branch node 102A collects data from all client devices 106 and branch nodes 102 connected to sub-networks 122A and 122D, which includes branch nodes 102B and 102E. Other embodiments use network topology such as star topology, ring topology, mesh topology, or bus topology, or a combination of any known network topology. In various embodiments, the branch nodes 102 are not the gateways, but rather a separate entity attached to the network 120 or sub-network 122, and rely on the gateways (which may be software or dedicated hardware; not shown in FIG. 1) to relay the collected data between branch nodes 102. Different pairs of branch nodes 102 may use different protocols to communicate with each other. For example, nodes 102A and 102B may communicate through a proxy server using TCP/IP, and nodes 102A and 102E may communicate directly using IPSec. Data collected by one branch node may be communicated to the first higher node in one protocol, and then to the next higher node in a different protocol.

The root node 104 collects, aggregates, and analyzes the data from all branch nodes 102, and, depending on the embodiment, provides routing instructions and authentication for the branch nodes 102. The root node 104 contains a data communication module 132, a data analysis module 134, a data store 136, a certificate module 142, and a certificate store 144. These components may all be included in one entity, such as a server at a remote site, or in multiple entities. For example, the certificate module 142 and certificate store 144 may be provided by a third party certificate authority, such as VERISIGN.

The data communication module 132 provides the root node 104 a way of sending and receiving (or collecting) data. Depending on the embodiment, the data communication module can send and receive data in at least one of several protocols, such as TCP/IP or SSH, and is capable of sending and receiving data of at least one of several types, such as certificates, factory status data, monitoring data, or similar such data. Data that the data communication module 132 receives may be stored in the data store 136.

The data analysis module 134 provides the root node 104 a way of analyzing the collected data. For example, if the data is factory status data for client devices 106 of a factory, the data analysis module 134 can perform an analysis of this data to determine the condition of the factory. The data analysis module 134 can prepare the analysis for local viewing, send the data to a remote data analysis station (not shown), store the data in the data store 136, etc.

The data store 136 provides the root node 104 a way of storing data collected by the data communication module 132 or the analysis generated by the data analysis module 134.

The certificate module 142 provides the root node 104 a way of generating, issuing, authenticating, and revoking certificates. The certificate module 142 communicates with the certificate store 144 to store certificates and any related data. A certificate is an electronic document that securely identifies an entity on a network 120 or sub-network 122, such as one of the branch nodes 102 or client devices 106. For example, each branch node 102 may have a certificate, wherein each certificate allows the other branch nodes 102 or client devices 106 to certify the identity of that branch node 102. The certificate can be a public key certificate, such as a X.509 certificate. Generating a certificate includes creating a secret private identifier, which will only go to the entity being certified (i.e., a branch node 102), and a public identifier, which can be used by the public to verify that the certified entity is authentic and is provided to all branch nodes 102. An identifier is a piece of information, such as an encryption key or hash algorithm, that can be used to uniquely verify the identity of the certified entity. In one embodiment, the private identifier and the public identifier are the encryption and decryption keys or an asymmetric encryption scheme. In the case of a public key certificate, the private identifier is a private key, and the public identifier is a public key. Each generated certificate may also be paired with a serial number. Issuing a certificate includes delivering the private identifier to the entity being signed. Authenticating a certificate includes checking the private identifier against the public identifier. In the case of a public key certificate, then the private identifier and the public identifier are compared according to the algorithm in use, such as RSA or ElGamal. Revoking a certificate includes marking the public identifier in some way to inform the public to no longer trust that identifier to authenticate the signed entity. In the case of a public key certificate, the certificate module may publish a certificate revocation list that lists the serial numbers of the revoked certificates.

The certificate store 144 provides the root node 104 a way of storing the generated certificates, and, depending on the embodiment, any information regarding revoked certificates.

The client devices 106 are any computing device on any network 120 or sub-network 122 that provides data to be communicated back to the root node 104. For example, in one embodiment the client device 106 is a data collection unit in a process control network of a factory. Client devices 106 on a sub-network 122 communicate their data to a branch node 102 on the sub-network 122. The branch node 102 collects this data and forwards it on to an upper node.

Note that the term client may refer to software providing client functionality, to hardware devices on which the software executes, or to the entities operating the software and/or hardware, as is apparent from the context in which the term is used.

The network 120 facilitates communication between the various components of the system environment. The network 120 is typically the Internet, but may be any network, including but not limited to a LAN, a MAN, a WAN, a mobile wired or wireless network, a private network, or a virtual private network.

The sub-network 122 facilitates communication between the various components of the system environment. The sub-network 122 is a network that is typically smaller than the network 120, such as a LAN, but may be any network, including but not limited to the Internet, a MAN, a WAN, a mobile wired or wireless network, a private network, or a virtual private network. The sub-network 122 may also be a process control network, which can be for example, a communications network that is used to transmit instructions and data between control measurement units and supervisory control and data acquisition (SCADA) equipment. A sub-network may be connected directly to a network or other sub-network, or through hardware such as a firewall or branch node 102.

Referring now to FIG. 2, illustrated is one embodiment of a branch node 102. The branch node includes a data collection module 202, a certificate store 204, and a network traversal module 210.

The data collection module 202 provides the branch node 102 a way of collecting data from client devices 106 on its network 120 or sub-network 122. For example, branch node 102C would use its data collection module 202 to collect data from the two client devices 106 which are on its sub-network 122C. The data collection module relays this data to the network traversal module 210. The data collection module 202 may provide a set of ports or services by which client devices can initiate connections or the data collection module may initiate connections with the client devices. Depending on the embodiment, the data collection module 202 may periodically initiate connection with client devices. The data collection module 202 may be manually or automatically configured to specifically communicate with only a subset of the client devices 106 on the network 120 or sub-network 122.

The certificate store 204 stores the private identifier of the certificate for the branch node 102. The private identifier is received from the root node 104 through the network traversal module 210. The public certificate of the root node 104 can also be saved to certificate store 204.

The network traversal module 210 provides the branch node 102 a way to securely communicate between networks. The network traversal module 210 includes a transmitting module 212, a listening module 214, a certificate send/receive module 216, and a certificate revocation module 218.

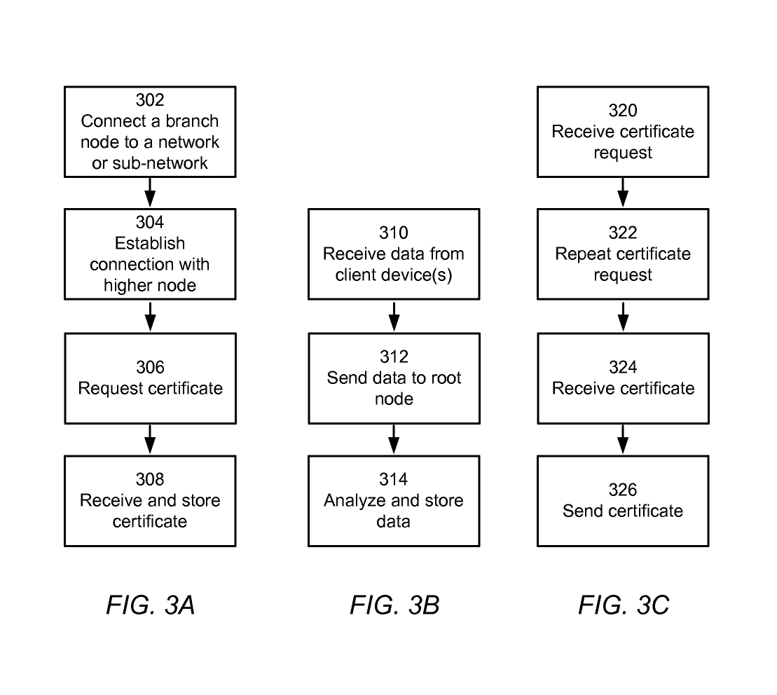

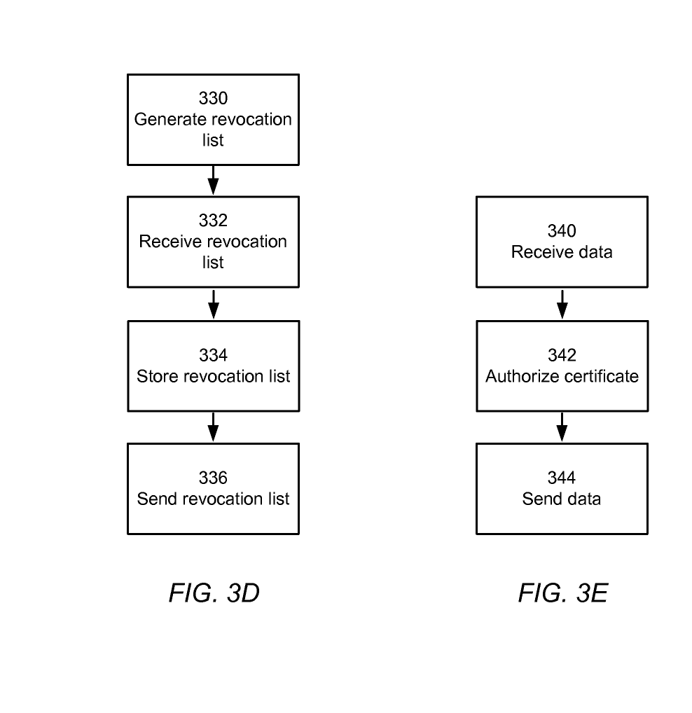

The transmitting module 212 provides the network traversal module 210 a way to communicate with a higher node. In general, such as in a tree network topology, the higher node is the next highest branch node 102 between the communicating branch node 102 and the root node 104. For example, the transmitting module 212 of branch node 102C would communicate to branch node 102B, and the transmitting module of branch node 102B would communicate to branch node 102A. If there are no branch nodes 102 between the communicating branch node 102 and the root node 104, then the higher node is the root node 104. For example, the transmitting module of branch node 102A would communicate to the root node 104. To establish communication with the higher node, the transmitting module 212 accesses open ports provided by the listening module 214 or the data communication module 132 and creates a data tunnel. The transmitting module 212 also signs the outgoing data using the private identifier for the branch node 102 that is stored in the certificate stored 204. This process is described in more detail below with respect to FIG. 3A-3E.

The transmitting module 212 takes the data from the data collection module 202 and sends it to the higher node. The transmitting module 212 may also receive data, such as commands or queries, from the higher node. The transmitting module is used in part by the certificate send/receive module 216 and certificate revoke module 218 in order to communicate with higher nodes.

The listening module 214 provides the network traversal module a way to communicate with a lower node. In general, such as in a tree network topology, lower nodes are the next lowest branch nodes 102, and are farther from the root node 104. For example, the listening module of branch node 102A would communicate to branch nodes 102B and 102E. The listening module 214 opens up one or more ports that allow the transmitting modules 212 of lower nodes to establish communication with the network traversal module. The listening module 214 receives data from the transmitting modules 212 of lower nodes, and passes that data to its own transmitting module 212 to be sent to the higher node. The listening module 214 may also send data to the lower node, but in general it only receives data. The listening module 214 is used in part by the certificate send/receive module 216 and certificate revoke module 218 in order to communicate with lower nodes.

The certificate send/receive module 216 provides the network traversal module 210 with a way of receiving and resending certificates. The certificate send/receive module 218 uses the transmitting module 212 to receive certificates originating with the root node 104 from higher nodes. If the certificate received is for the current branch node 102, then the certificate send/receive module 218 passes the certificate and its associated private key to the certificate store 204. Otherwise, the certificate send/receive module 218 passes the certificate to the listening module 212 to be passed down to lower nodes. The certificate send/receive module 218 may first analyze the lower nodes and pass certificates on to only the proper nodes. If the network is multiple levels deep, then the certificate send/receive module 218 may first instruct the listening module 214 to query lower nodes to determine if any of the lower nodes, or their lower node, etc. are the proper destination for the certificate, and then send the certificate to lower node with instructions to pass it on to its lower node.

The certificate/send module 216 enables the branch node 102 to participate in the trust hierarchy that is rooted at the certificate authority and extends to the leaf-level branch nodes 102 in one unbroken chain, no matter how many different network boundaries are spanned. Furthermore, the logical trust hierarchy is mapped onto a physical network topology, such that the trust chain and the data traversal path can be viewed as a single entity.

The certificate revocation module 218 provides the network traversal module 210 with a way of learning about revoked certificates. The root node 104 may generate a certificate revocation list and pass it to its lower nodes. These nodes receive the list using their transmitting modules 212 and pass it to the certificate revocation module 216. The certificate revocation module 216 stores the list in the certificate store 204, and passes it to all other lower nodes using the listening module 214. The certificate revocation module 216 also checks the certificates from lower nodes to verify their identity before passing data received from the lower nodes to the higher nodes. The certificate revocation module 216 checks the certificate from a lower node through an authentication process that checks the public key of the certificate against the private key of the certificate.

The network traversal module 210 effectively replicates the data collection and authentication functions from the root node 104 at each branch node 102. Thus, each branch node 102 can authenticate a certificate of a lower node as it receives collected data from the lower node. If a certificate is authenticated, the branch node 102 forwards the data on to a higher level node. If the certificate is not authenticated, the data is considered to be from an un-authenticated source, and so the data is not forwarded on to a higher level branch node 102.

The certificate of a lower branch node 102 is authenticated multiple times, once at each upper branch node 102, before it finally reaches the root node 104. For example, branch node 102C may collect data from the client devices 106 and sign the data with the private identifier of its certificate. The data is sent to branch node 102B, which authenticates the certificate of branch node 102C using the public identifier for branch node 102C. Similarly, when the data is forwarded from branch node 102B to branch node 102A, branch node 102A will also authenticate the certificate of branch node 102C using the public identifier for node 102C.

Secure networks generally do not allow data to cross network boundaries, which prevents certificate services, such as Active Directory Certificate Services, from functioning across network boundaries. However, by authenticating the certificate at the boundary of each network, certificate services can be easily extended across multiple secure networks. Additionally, maintaining and updating certificate revocation lists at each branch node 102 enables automatic blocking of a branch node 102 once the branch node's certificate is revoked.

### Establishing Secure Communication Between Networks

Referring now to FIGS. 3A-F, illustrated are example flow charts showing establishing secure communication between networks based on the system environment described above. FIG. 3A describes the process of adding a new branch node.

First, a branch node 102 is connected 302 to a network 120 or sub-network 122. This may come in the form of attaching a physical device to the network, such as a server, which contains software enabling the branch node functionality. It may also come from installing such software on a physical device already attached to the network. In some cases, connecting the branch node 102 also encompasses creating a sub-network attached to the branch node 102. At the time of setup, the branch node software may request a username and password to authenticate the user. The branch node 102 may also require a manually specified network topology.

Then, the branch node 102 establishes 304 a connection with the higher node. The branch node uses its transmitting module 212 to access the open ports or listening module 214 of the higher node. This connection may be made using TCP/IP, SSH, or any know protocol or communication system. As part of establishing a connection, the higher node may inform its higher node, all the way to the root node 104, about the new branch node.

Next, the branch node 102 requests 306 a certificate from the higher node. The branch node uses its certificate send/receive module 216 and the transmitting module 212 to make the request. The higher node then relays the request to its higher node, securing the branch node's credentials all the way to the root rode 104.

Then, the root node 104 creates a certificate with its certificate module 142, stores the certificate in the certificate store 144, and then passes the certificate back down to the branch node 102. The branch node 102 then receives and stores 308 the certificate in the certificate store 204. At this point the new branch node 102 has verified the identity of the issuing authority (i.e. the root node 104), trusts the branch node 102 above, and the branch node 102 above trusts the new branch node 102. They both belong to the same trust hierarchy, despite the fact that they may reside in separate network domains. The procedure outlined in FIG. 3A starts with the topmost branch node 102A communicating for the first time with the root node 104 and is replicated down the entire trust chain to the leaf level branch nodes 102.

FIG. 3B illustrates a process for gathering data and sending to the root node 104 in one embodiment. First, the branch node 102 receives 310 data from the client devices 106 on its network 120 or sub-network 122. The branch node 102 uses the data collection module 202 to communicate with the client devices. The data collection module then passes the data to the transmitting module 212, which signs the data with the private identifier of the certificate for the branch node 102.

The branch node 102 then sends 312 the data to the root node 104. If necessary, the transmitting module 212 first reformats the data to be compatible with the communication protocol used to communicate between nodes. The transmitting module then sends the data to the higher node. The higher node then authenticates the certificate for the lower node that collected the data, as described in FIG. 3E. The higher node then relays the data up, until the data reaches the root node 104. Authentication occurs at each branch node 102 that is traversed until the data reaches the root node 104

The root node 104 then decrypts, analyzes and stores 314 the data. The root node 104 authenticates the certificate of the branch node 102 that collected the data using the public key associated with the certificate. The root node uses the communication module 132 to receive the data, and then it stores it in the data store 136 if the certificate is authenticated. The root node may also analyze the data with the data analysis module 134, and store this analysis in the data store 136.

FIG. 3C illustrates a process for transmitting certificates in one embodiment. First, a branch node 102 receives 320 a certificate request from a lower node, or from a lower node on behalf of a lower node two or more levels removed. This request is received by the listening module 214. As described above, this request may come at a time when the lower node is first added to the system, or it may come at a time when the lower node has an expired or revoked certificate, and it needs a new certificate.

The branch node 102 then repeats 322 this request to the higher node using the transmitting module as described in step 306 above. After the root node 104 processes the request and sends down the certificate, the branch node 102 receives 324 the certificate as described in step 308 above. However, instead of storing the certificate, the branch node 102 identifies which of its lower node originated the certificate request, and sends 326 the certificate to that node. The certificate send/receive module 216 sends the certificate by passing the certificate to the listening module 214, which transmits it to the lower node. If the originator is more than one level away, then the branch node 102 identifies the next lowest and sends the certificate to this node, which continues to send it until it reaches the originating node, which stores it as described above in step 306.

FIG. 3D illustrates a process for revoking a certificate according to one embodiment. First, the root node 104 generates 330 a certificate revoke list using the certificate module 142. This list includes all revoked certificates. This step may be prompted by a compromised node, which needs to be no longer trusted, so its certificate needs to be revoked. The certificate module then sends the revoke list using the data communication module 132 to all the lower nodes. The certificate revocation list allows any branch node 102 to deny access from any node 102 whose public key matches the public key of a revoked certificate.

A branch node 102 receives 332 the revoke list from a higher node. The branch node 102 receives the certificate through the transmitting module 212, which passes it on to the certificate revoke module 218. The certificate revoke module then stores 334 the revoke list in the certificate store 204. After storing the list, the module then sends 336 the certificate revoke list to all lower nodes using the listening module 212. All these lower nodes resend the revoke list to all their lower nodes.

FIG. 3E illustrates a process for authorizing a certificate according to one embodiment. First, a branch node 102 receives 340 a data transmission from a lower node through the transmitting module 212. As part of the data transmission, the lower node includes its certificate and signs the data and certificate with the private identifier of the certificate. The private identifier itself is not part of the data transmission. The branch node 102 transfers the certificate to the certificate revoke module 218.

The certificate revoke module 218 then authenticates 342 the certificate of the lower node. To authenticate the first certificate, the certificate revoke module compares the certificate to the certificate revoke list. If the certificate from the lower node is on the revoke list, then the certificate revoke module 218 does not authenticate the certificate. However, if the certificate is not on the revoke list, then it compares the public identifier of the certificate and the private identifier of the certificate to verify the identity of the lower node. In specific, it verifies the identity of the lower node by calculating the relationship of the public identifier of the certificate to the private identifier which was previously used to sign the data. If the relationship is not valid, the authentication fails.

If the identity is properly verified, the transmitting module 212 then sends the data to the higher node. If the higher node is not a root node 104, then the higher node continues to reauthenticate and resend the data until it reaches the root node. Each branch node 102 thus replicates the authentication operations of the root node 104, and only forwards on the data to a higher node if the certificate from the originating branch node 102 can be authenticated. The result is that certificate services, such as Active Directory Certificate Services, can be extended through multiple networks.

### Additional Configuration Considerations

The Figures and this specification relate to embodiments by way of illustration only. It should be noted that alternative embodiments of the structures and methods disclosed herein will be readily recognized as viable alternatives that may be employed without departing from the principles of what is claimed.

It is noted that wherever practicable similar or like reference numbers may be used in the figures and may indicate similar or like functionality. The figures depict embodiments of the disclosed system (or method) for purposes of illustration only. One skilled in the art will readily recognize from the specification that alternative embodiments of the structures and methods illustrated herein may be employed without departing from the principles described herein.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a non-transitory machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory), for example, as described and illustrated with FIG. 3. These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for more efficiently handling shared code stored in memory, through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A system for providing secure communications in a network topology, the system comprising:
a first module of a first node, the first node coupled to a first network and including a certificate for the first node, the first module adapted to send collected data via the first network using the certificate;
a second module of a second node, the second node coupled to the first network and a second network, the second module adapted to receive the collected data via the first network, to authenticate the certificate for the first node based on a public key associated with the certificate, and to send the collected data via the second network responsive to authenticating the certificate; and
a third node coupled to the second network, the third node adapted to receive the collected data via the second network, to authenticate the certificate for the first node based on the public key associated with the certificate, and to store the collected data received via the second network responsive to authenticating the certificate for the first node.

2. The system of claim 1, wherein the third node is adapted to generate the certificate for the first node, to generate the public key, and to provide the certificate to first node via the second node.

3. The system of claim 1, further comprising a data analysis module coupled to the third node, the data analysis module adapted to analyze the collected data.

4. The system of claim 1, where the second node and third node each include a respective certificate revocation list, and the second node and third node are each adapted to use the respective certificate revocation list to authenticate the certificate of the first node.

5. The system of claim 1, wherein the first node is adapted to collect the collected data from a plurality of client devices via a process control network.

6. The system of claim 5, wherein the collected data is factory status data.

7. A method for providing secure communication in a network topology, the method comprising
receiving collected data from a first node via a first network, the first node including a certificate for the first node, the collected data received at a second node;
authenticating, at the second node, the certificate for the first node based on a public key associated with the certificate for the first node; and
sending the collected data from the second node to a third node via a second network responsive to authenticating the certificate at the second node, the third node authenticating the certificate for the first node based on the public key associated with the certificate and storing the collected data responsive to authenticating the certificate for the first node at the third node.

8. The method of claim 7, further comprising:
receiving, at the second node, the certificate for the first node, the certificate generated by the third node; and
sending the certificate from the second node to the first node.

9. The method of claim 7, where authenticating the certificate for the first node comprises authenticating the certificate using a certificate revocation list.

10. The method of claim 7, wherein the first node is adapted to collect the collected data from a plurality of client devices via a process control network.

11. The method of claim 10, wherein the collected data is factory status data.

12. A non-transitory machine readable medium for providing secure communication in a network topology, the machine readable medium storing code for:
receiving collected data from a first node via a first network, the first node including a certificate for the first node, the collected data received at a second node;
authenticating, at the second node, the certificate for the first node based on a public key associated with the certificate for the first node; and
sending the collected data from the second node to a third node via a second network responsive to authenticating the certificate at the second node, the third node authenticating the certificate for the first node based on the public key associated with the certificate and storing the collected data responsive to authenticating the certificate for the first node at the third node.

13. The machine readable medium of claim 12, the code further comprising code for:
receiving, at the second node, the certificate for the first node, the certificate generated by the third node; and
sending the certificate from the second node to the first node.

14. The machine readable medium of claim 12, where authenticating the collected data comprises authenticating the data using a certificate revocation list.

15. The machine readable medium of claim 12, wherein the first node is adapted to collect the collected data from a plurality of client devices via a process control network.

16. The machine readable medium of claim 15, wherein the collected data is factory status data.
